(19) United States
(12) Patent Application Publication
(10) Pub. No.: US 2014/0345884 A1
(43) Pub. Date: Nov. 27, 2014

(54) APPARATUS AND METHODS FOR FIGHTING OFFSHORE FIRES

(71) Applicant: Anh LUONG, Seabrook, TX (US)

(72) Inventor: Anh Luong, Seabrook, TX (US)

(21) Appl. No.: 14/360,469

(22) PCT Filed: Nov. 21, 2012
(86) PCT No.: PCT/US12/66229

§ 371 Date: May 23, 2014

Related U.S. Application Data
(60) Provisional application No. 61/563,230, filed on Nov. 23, 2011.

(51) Int. Cl. A62C 29/00

(52) U.S. Cl. CPC A62C 29/00
USPC 169/46; 169/52

(57) ABSTRACT

An offshore firefighting apparatus for subduing an offshore fire includes a vessel; a jet engine coupled to the vessel; and a dynamic positioning system for positioning the vessel. One or more vessels are placed in the vicinity of an offshore fire with the exhaust side of the jet engines pointed toward the fire. As the jet engines are operated, exhaust from the jet engines subdues the fire. The dynamic positioning system on the vessel controls vessel movement during the fire fighting operation.

### BACKGROUND OF THE INVENTION

1. Field of the Invention

Embodiment of the present invention relates to fighting fires, and more particularly, to apparatus and methods for fighting fires offshore.

2. Description of the Related Art

Offshore fires pose a serious risk, and current methods of fighting these fires are not always successful. Water and chemicals are usually used in an attempt to suppress the fire, but often, the temperature of the fire is so great that the water and chemicals evaporate or disintegrate before effectively fighting the core of the fire. Therefore, water and chemicals do very little to suppress an offshore fire. If water and chemicals do suppress an offshore fire, an extended period of time has elapsed, and substantial damage to an offshore rig and surrounding environment has occurred. What is needed is an apparatus and method that will effectively cool down and suppress an offshore fire.

### SUMMARY OF THE INVENTION

The present invention includes an apparatus and method for fighting fires offshore. In one embodiment, one or more jet engines are mounted to a vessel and an exhaust outlet on each jet engine is directed toward an offshore fire to cool and suppress a source of fire. The vessel may include a dynamic positioning system, which helps maintain the vessel's position when the turbofan is engaged. In one embodiment, the jet engine is selected from the group consisting of turbofan and turbojet.

One or more vessels having one or more turbofans may be used at the same time to fight an offshore fire. In one embodiment, more than one vessel with one or more turbofans are placed at different angles relative to the source of fire to combat the fire. In another embodiment, the vessel may also include a crane, which can position the turbofan on the vessel, and thus the exhaust outlet of the turbofan, so that fires can be targeted more easily. In yet another embodiment, the exhaust of the turbofans may be directed through a rotatable high velocity nozzle, to target fires more easily.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of one embodiment of an offshore firefighting apparatus, wherein a turbofan is located and coupled to a vessel and is used to fight fires.

FIG. 2 is an illustration of the turbofan that is to be coupled to a vessel for purposes of fighting fires.

FIG. 3 is an illustration of another embodiment of the offshore firefighting apparatus, wherein a crane is used to position the turbofan for purposes of fighting fires.

FIG. 4 is an illustration of the offshore firefighting apparatus, wherein the turbofan is mounted to the crane for purposes of fighting fires.

FIG. 5 is a diagram of an alternate embodiment of an offshore firefighting apparatus, wherein two turbofans are located and coupled to the vessel.

FIG. 6 is a top view of an embodiment of the offshore firefighting apparatus with two turbofans located and coupled to the vessel.

FIG. 7 is an illustration of an embodiment of the offshore firefighting apparatus, wherein the turbofan is connected to a rotatable high velocity nozzle.

FIG. 8 is an illustration of a method for fighting offshore fires, wherein multiple vessels equipped with turbofans are positioned at different angles relative to the offshore fire in order to extinguish the fire.

### DETAILED DESCRIPTION

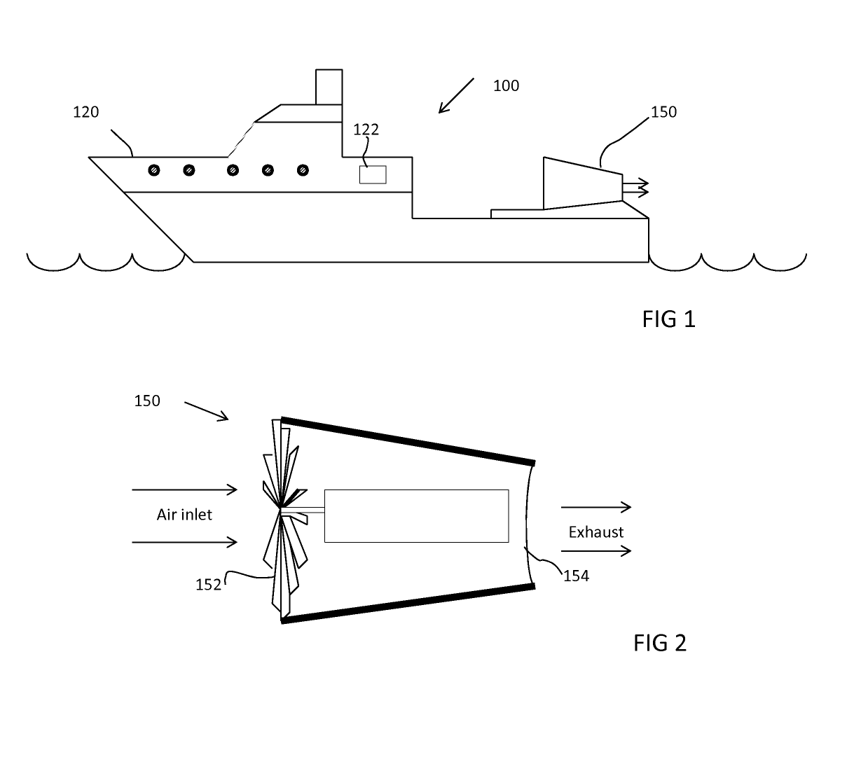

The present invention includes an apparatus and method for fighting fires offshore. As shown in FIG. 1, the offshore firefighting apparatus 100 may include a vessel 120 that is equipped with a turbofan 150. The vessel 120 may position itself in the vicinity of an offshore fire when the need arises. Power from the vessel 120, or a separate independent power source, may be used to operate the turbofan 150. When the turbofan 150 is in operation, exhaust from the turbofan 150 is used to cool and subdue the fire. A dynamic positioning system (“DPS”) on the vessel may counterbalance the thrust produced by the turbofan to ensure the vessel stays in substantially the same position. In another embodiment, the DPS may counterbalance the thrust from the turbofan and also move the vessel to a different position. FIG. 1 shows an offshore firefighting apparatus 100, wherein a turbofan 150 is located and fixed at the stern-side of a vessel. The turbofan 150 may be rotated in any direction relative to the vessel 120. In one example, the turbofan 150 may include a gas turbine engine and a fan. In addition to a turbofan, other suitable types of jet engines include a turbojet, low bypass turbofan, and high bypass turbofan.

FIG. 2 illustrates an exemplary embodiment of a turbofan that can be coupled to the vessel 120 for purposes of fighting fires. Air enters a suction side 152 of the turbofan and exits an exhaust side 154 of the turbofan. The exhaust side 154 is positioned toward the vicinity of the fire in order to subdue the fire. The exhaust side 154 may include a positionable nozzle for directing the exhaust air to a certain location.

The DPS is a computer controlled system configured to maintain the position of the vessel 120. The DPS includes a controller 122, one or more propellers, and one or more thrusters for positioning the vessel 120. The DPS may also include position reference sensors, wind sensors, motion sensors and gyro compasses in order to determine the position of the vessel 120 and to determine the forces acting on the vessel 120. The DPS of the offshore firefighting apparatus 100, as disclosed herein, may be operated to counterbalance the forces and thrust produced by the turbofan 150 in order to allow the vessel 120 to stay in one position or to move to a different position when fighting an offshore fire.

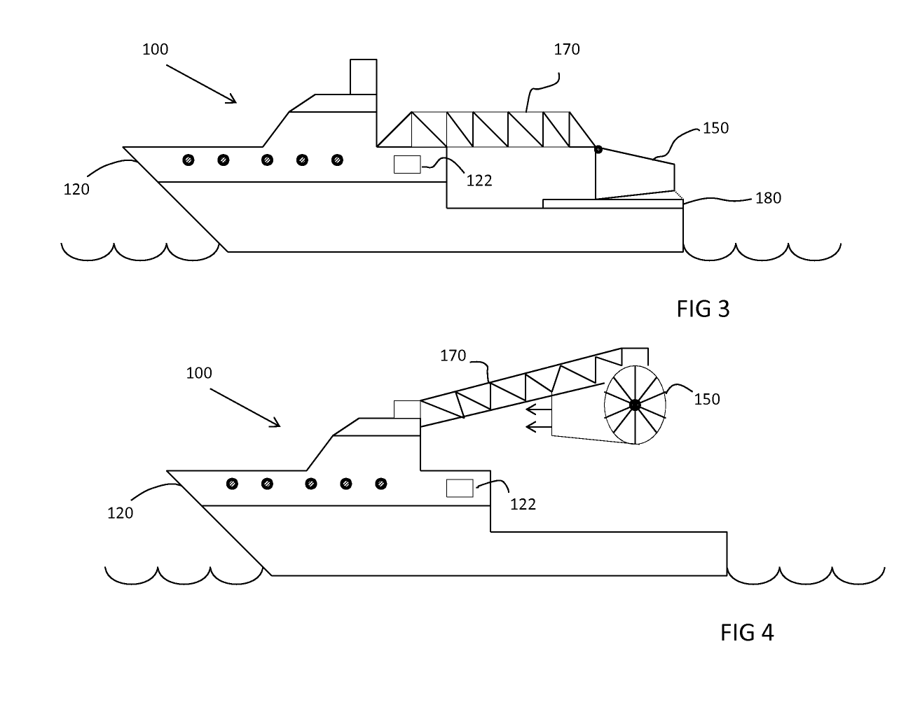

FIG. 3 is an illustration of another embodiment of the offshore firefighting apparatus, wherein the turbofan 150 is mounted to a rotatable skid 180. The rotatable skid 180 may include a motor to rotate the skid 180. The rotatable skid 180 may be locked into position on the vessel 120 to maintain the turbofan 150 in position. When the rotatable skid 180 is unlocked, the turbofan 150 may be rotated into different positions relative to the vessel 120. In another embodiment, the skid 180 may be raised or lowered to facilitate the proper positioning of the turbofan 150. In yet another embodiment, the turbofan 150 may be pivotally mounted to the skid 180. In this respect, the exhaust from the turbofan 150 may be directed at an optimal angle toward the fire. In another embodiment, a crane 170 may optionally be used to rotate the turbofan 150 and the skid 180. In this configuration, the crane 170 may be mounted to the vessel 120 in any location that provides a convenient access point to the turbofan 150.

In a different embodiment, as shown in FIG. 4, the turbofan 150 is mounted to a distal end of the crane 170 on the vessel 120. The crane 170 may be mounted to the vessel 120 at any location so long as the weight and force from the crane 170 with an operational turbofan 150 may be adequately supported. The crane 170 may be configured to move the turbofan 150 in at least two degrees of freedom, and preferably, in at least six degrees of freedom. In this configuration, the crane 170 may direct the turbofan 150 in any position relative to the vessel 120, and may extend the turbofan 150 toward the source of fire.

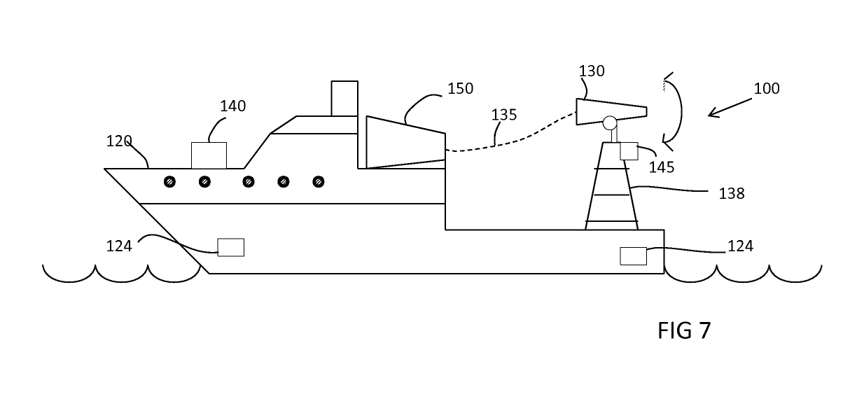

FIG. 5 is a diagram of an alternate embodiment of an offshore firefighting apparatus 100, wherein multiple turbofans 150A, B are located and coupled to the vessel 120. High velocity nozzles 130A, B may be connected to the turbofans 150A, B by a tubular 135 that can withstand the resulting forces of the exhaust coming from the turbofans 150A, B (see FIG. 7). The high velocity nozzles 130A, B may position the exhaust from the turbofans 150A, B to a specific location of the fire, and may rotate both in a horizontal direction and vertical direction. In a preferred embodiment, the high velocity nozzles 130A, B may rotate along the horizontal axis, relative to the vessel 120, up to approximately 90 degrees; preferably, up to 45 degrees. The high velocity nozzles 130A, B may also rotate along the vertical axis, relative to the vessel 120, up to 45 degrees (see FIG. 7). The positioning of the nozzles 130A, B could be done manually or by a remote device. If multiple turbofans 150 A, B are used on a single vessel 120, it is preferred that the nozzles 130A, B not be allowed to rotate toward each other.

A central control panel 140 may control the turbofans 150A, B and/or the nozzles 130A, B. In one embodiment, a single turbofan 150 may be provided on the vessel 120 of the firefighting apparatus 100, and a nozzle 130 may be connected to the turbofan 150 by a tubular 135. In another embodiment, an optional chemical mixer 133 may be provided between the turbofan 150A, B and the nozzle 130A, B. The chemical mixer 133 may be used to supply and mix a fire retardant chemical with the exhaust to aid firefighting. Exemplary fire retardant chemicals include fire fighting foams and gels. Alternatively, the chemical mixer 133 may be used to supply and mix water with the exhaust to aid firefighting.

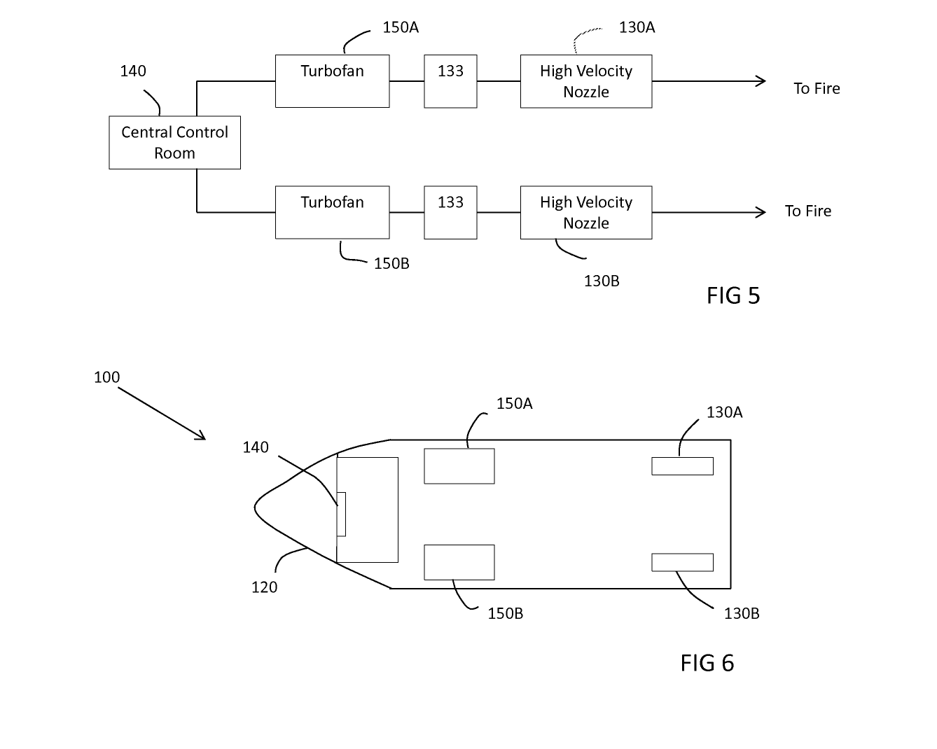

FIG. 6 is a top view of an embodiment of the offshore firefighting apparatus 100 with two turbofans 150 A, B and two nozzles 130 A, B located and coupled to the vessel 120. As shown, the turbofans 150A, B are positioned on each side of the vessel 120 to assist with balancing of the vessel 120. The nozzles 130A, B are positioned near the end of the vessel 120 and spaced on each side of the vessel 120. However, it is contemplated that the turbofans and nozzles may be positioned in any suitable arrangement on the vessel 120.

FIG. 7 is an illustration of an embodiment of the offshore firefighting apparatus 100, wherein the turbofan 150 is connected to a rotatable high velocity nozzle 130. The nozzle 130 is mounted on a stand 138 located at the back of the vessel 120. The nozzle 130 may be rotated horizontally and/or vertically to direct the exhaust in the desired location. The stand 138 may include a plurality of legs that are anchored to the floor of the vessel 120. In another embodiment, the stand 138 may attached to a skid for rotating and vertical movement. In addition to controlling the turbofan 150 and the nozzle 130, the control panel 140 may be integrated with DPS components 124, which may include thrusters and propellers, to enable the DPS components 124 to maintain position and/or heading of the vessel 120.

In an alternate embodiment, a thermographic camera 145 may be mounted on the vessel 120 or on any suitable component coupled to the vessel 120. The thermographic camera 145 may be used to identify temperature variations of the fire or the burning offshore structure by forming an image of the fire or the structure using infrared radiation. In FIG. 7, the thermographic camera 145 is mounted to the stand 138 and is used to detect heat sources, such as a fire on an offshore rig. In one embodiment, the thermographic camera may be connected to the control panel 140, which in turn is connected to the nozzle 130. The nozzle 130 may be actuated by the control panel to direct the turbofan exhaust toward the highest temperature zone of fire as indicated by the thermographic camera 145. In a different embodiment, the thermographic camera 145 could be connected to a control system that remotely positions the nozzle 130 and/or turbofan 150 exhaust toward the heat source.

As discussed above, it is envisioned that one or more turbofans 150 and one or more nozzles could be used on a single vessel 120 to fight offshore fires.

A method of using the offshore firefighting apparatus 100 includes positioning the vessel 120 near the vicinity of an offshore fire and placing the exhaust side 154 of one or more turbofans 150 in the direction of the offshore fire. The vessel 120 operates the turbofans 150 and the DPS provides sufficient thrust to prevent the vessel 120 from substantially moving when the turbofans 150 are in use. The exhaust of the turbofan 150 may be controlled to subdue the offshore fire.

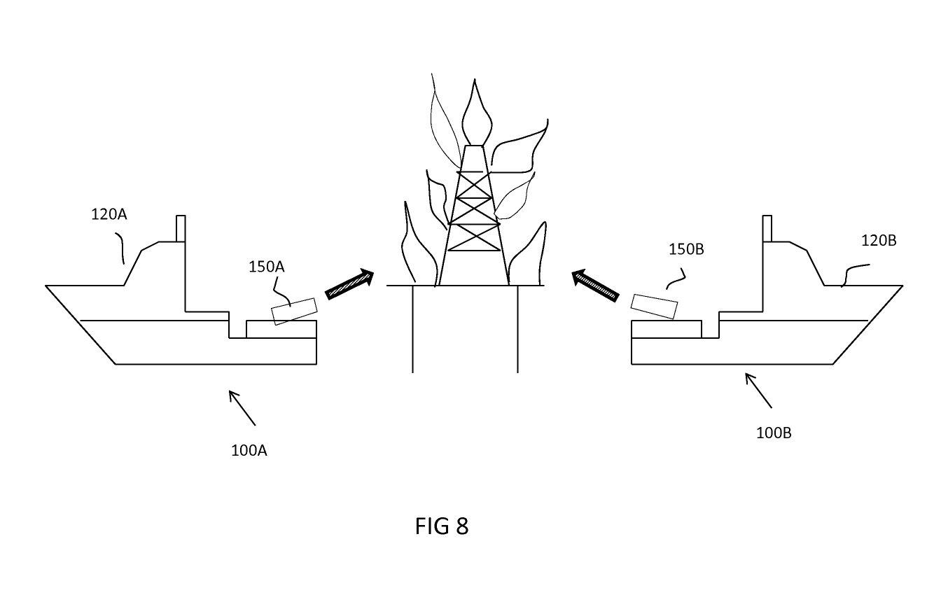

An alternate method of using the offshore firefighting apparatus 100 is seen in FIG. 8. In this embodiment, two vessels 120A, B are positioned near the vicinity of an offshore fire and are placed in various angles relative to such fire. The exhaust side 154 of the turbofans 150A, B that are mounted on each vessel 120A, B are placed in the direction of the offshore fire. In one embodiment, the turbofans 150A, B are positioned at approximately 180 degrees from each other. In this respect, the turbofans 150A, B may attack the fire from opposing sides. For example, the DPS may be operated to keep the vessels 120A, B parallel to and opposite each other. The turbofans 150A, B and nozzles 130A, B on the opposing vessels 120A, B are operated to output exhausts that are of substantially equal force and intensity to subdue the fire.

In another embodiment, the turbofans 150A, B are separated from each other at an angle between 90 degrees and 180 degrees. While the turbofans 150A, B are in use, the DPS on each vessel 120A, B may be operated to provide enough thrust to prevent the vessels 120A, B from substantially moving. Although two vessels are disclosed, any suitable number of vessels equipped with a turbofan may be used. For example, four vessels may be positioned around the location of the fire and at about ninety degrees from an adjacent vessel to fight an offshore fire. In addition, although one turbofan 150 is shown per vessel 120 in FIG. 8, any suitable number of turbofans 150 may be used on the vessel 120. Furthermore, nozzles 130 could be connected to one or more turbofans 150 on the vessel 120, for positioning the exhaust towards the source of fire. The nozzles 130 may also be connected to the thermographic camera 145 via a control system that may direct the nozzles 130 based on heat sources sensed by the camera 145.

In another embodiment, a method of fighting offshore fires includes positioning a vessel near an offshore fire, wherein the vessel includes a jet engine and a dynamic positioning system; connecting an exhaust side of the jet engine to a rotatable nozzle; operating the jet engine to generate exhaust from the jet engine; positioning the nozzle toward the offshore fire to direct the exhaust from the jet engine towards the fire; and operating the dynamic positioning system to provide sufficient thrust to counterbalance reaction forces on the vessel generated from the jet engine.

While the foregoing is directed to embodiments of the present invention, other and further embodiments of the invention may be devised without departing from the basic scope thereof, and the scope thereof is determined by the claims that follow.

1. An offshore firefighting apparatus for subduing an offshore fire, comprising:
a vessel;
a jet engine coupled to the vessel; and
a dynamic positioning system for positioning the vessel.

2. The offshore firefighting apparatus of claim 1, wherein an exhaust from the jet engine is used to subdue the offshore fire.

3. The offshore firefighting apparatus of claim 2, wherein the dynamic positioning system counterbalances the forces placed on the vessel when the jet engine is operating.

4. The offshore firefighting apparatus of claim 1, further comprising a crane for positioning the turbofan.

5. The offshore firefighting apparatus of claim 4, wherein the crane couples the jet engine to the vessel.

6. The offshore firefighting apparatus of claim 5, wherein the crane is configured to move the jet engine in at least two degrees of freedom.

7. The offshore firefighting apparatus of claim 1, further comprising a positionable nozzle attached to an exhaust side of the jet engine.

8. The offshore firefighting apparatus of claim 1, wherein multiple jet engines are coupled to the vessel.

9. The offshore firefighting apparatus of claim 1, further comprising a tubular and a positionable nozzle, wherein the jet engine is connected to the positionable nozzle by the tubular.

10. The offshore firefighting apparatus of claim 1, wherein the jet engine is selected from the group consisting of a turbofan, a turbojet, a low bypass turbofan, and a high bypass turbofan.

11. A method of fighting offshore fires, comprising:
positioning a vessel near an offshore fire, wherein the vessel includes a jet engine and a dynamic positioning system;
directing an exhaust side of the jet engine toward the fire;
operating the jet engine to generate exhaust from the jet engine to subdue the offshore fire; and
operating the dynamic positioning system to provide sufficient thrust to counterbalance reaction forces on the vessel generated from the jet engine.

12. The method of claim 11, wherein two vessels equipped with the jet engine are used to fight an offshore fire.

13. The method of claim 12, wherein one or more vessels are equipped with more than one jet engine.

14. The method of claim 11, further comprising maintaining a position of the vessel during operation of the jet engine.

15. The method of claim 14, wherein the position is maintained by the dynamic positioning system.

16. The method of claim 11, further comprising operating the dynamic positioning system to move the vessel while operating the jet engine.

17. The method of claim 1, wherein the jet engine is selected from the group consisting of a turbofan, a turbojet, a low bypass turbofan, and a high bypass turbofan.

18. A method of fighting offshore fires, comprising:
positioning a vessel near an offshore fire, wherein the vessel includes a turbofan and a dynamic positioning system;
connecting an exhaust side of the turbofan to a rotatable nozzle;
operating the turbofan to generate exhaust from the turbofan;
positioning the nozzle toward the offshore fire to direct the exhaust from the turbofan towards the fire; and
operating the dynamic positioning system to provide sufficient thrust to counterbalance reaction forces on the vessel generated from the turbofan.

19. The method of claim 18, wherein more than one vessel equipped with the turbofan is used to fight an offshore fire.

20. The method of claim 19, wherein one or more vessels are equipped with multiple turbofans.

21.-24. (canceled)
